(19) United States
(12) Patent Application Publication
(10) Pub. No.: US 2016/0236371 A1
(43) Pub. Date: Aug. 18, 2016

(54) Hollowing System for a Wood Lathe

(71) Applicant: Tillman Tazwell Bramlette, III, Santa Fe, NM (US)

(72) Inventor: Tillman Tazwell Bramlette, III, Santa Fe, NM (US)

(21) Appl. No.: 14/625,113

(22) Filed: Feb. 18, 2015

(51) Int. Cl. B27C 7/06

(52) U.S. Cl. CPC B27C 7/06

(57) ABSTRACT

The present invention relates to an external apparatus that attaches to, or is mounted adjacent to, a woodturning lathe in order to hold and control the motion of cutting tools used for shaping and hollowing vessels and bowls mounted on the lathe. Wood lathes have existed for over two thousand years and most frequently have relied upon handheld tools to accomplish the shaping and hollowing of wood. This approach is adequate for smaller projects involving relatively uniform woods. However, for larger projects utilizing more interesting woods (burls, crotches, roots and stumps) that may include knots, voids, inclusions, debris, metal objects, and complex grain structures, a more robust method for holding and controlling the cutting tools is required. The present apparatus is also useful for wood turners who may be experiencing certain physical limitations.

### STATEMENT REGARDING FEDERALLY SPONSORED R & D

None

### NAMES OF PARTIES TO A JOINT RESEARCH AGREEMENT

None

### CROSS REFERENCE TO RELATED APPLICATIONS

None

### BACKGROUND OF THE INVENTION

1. Field of the Invention

The present invention relates to an external apparatus that attaches to, or is mounted adjacent to, a woodturning lathe in order to hold and control the motion of cutting tools used for shaping and hollowing vessels and bowls mounted on the lathe. Wood lathes have existed for over two thousand years and most frequently have relied upon handheld tools to accomplish the shaping and hollowing of wood. This approach is adequate for smaller projects involving relatively uniform woods. However, for larger projects utilizing more interesting woods (burls, crotches, roots and stumps) that may include knots, voids, inclusions, debris, metal objects, and complex gram structures, a more robust method for holding and controlling the cutting tools is required. The present apparatus is also useful for wood turners who may be experiencing certain physical limitations.

2. Description of the Prior Art

Previous hollowing systems may be broadly characterized as either “articulating arm” or “capture” types. Systems that have been patented are noted below.

U.S. Pat. No. 8,042,435 by Ray P. Thompson, et al. describes a “Special Articulating Tool Holder” comprising multiple articulating arms, a vertical mounting post and method for holding a variety of cutting tools. This system can experience significant vibration for deep aggressive cuts, and in certain orientations experience a tendency to have the articulating arms lock.

U.S. Pat. No. 7,191,689 B2 by Keith Clark describes a “Hollowing System” that controls the cutting tool movements along certain axes while allowing full movement along other axes. While the figures show the stabilization assembly mounted on the lathe, the Claims are for a stabilization assembly mounted adjacent to the lathe.

For both of these hollowing systems there comes a point where the hollowing system becomes physically decoupled from the lathe. For the “Special Articulating Tool Holder” the decoupling occurs at the tool rest, while for the “Hollowing System” the decoupling occurs at the tool rest and because the stabilization assembly is mounted adjacent to the lathe. In both instances, this decoupling can lead to hollowing system vibrations and resonances induced by cutting tool chatter and catches, making it more difficult to make accurate and repeatable hollowing cuts. The present invention mitigates the possibility of tool chatter and catches with multiple techniques that include friction control, vibration damping, close and adjustable tolerances, and robust system mass.

### BRIEF SUMMARY OF THE INVENTION

The present invention provides a method and apparatus for the longitudinal, lateral, vertical and rotational control of a toolbar that can hold a variety of cutting tools. The assemblies that comprise the complete system are interconnected in such a way that the friction and rigidity between the toolbar and the various assemblies can be controlled and varied easily. Moreover, the materials of construction for certain of the assemblies provide friction control and vibration damping.

It is therefore a primary object of the present invention to provide a method and apparatus that will enable a wood turner to concentrate on the form of a vessel being turned on a wood lathe without being overly concerned with countering the various forces that are experienced as the hollowing and shaping of the vessel progresses.

It is another object of the present invention, to provide an adjustable method to control the longitudinal (along the long axis of the lathe) force on the tool bar caused by the tendency of a cutter to self-feed as the vessel rotates.

It is a further object of the present invention to provide an adjustable method to control the lateral (at right angle to longitudinal axis of the lathe) force on the toolbar caused by the tendency of the cutter to self-feed as the vessel rotates.

It is still another object of the present invention to provide an adjustable method to control the torsion force (the force that twists the toolbar about its longitudinal axis) caused by a cutter that is not aligned with the toolbar axis of rotation.

It is still a further object of the present invention to provide a method to control the vertical force (the force that tends to raise the end of the toolbar vertically) caused by the moment induced by the overhang of the toolbar from its last vertical support.

These and other objects of the present invention will become apparent to those skilled in this art upon reading the accompanying description, drawings, and claims set forth herein.

### BRIEF DESCRIPTION OF THE DRAWINGS

The accompanying drawings illustrate a preferred and an alternative embodiment for the Hollowing System for a Wood Lathe. The drawings together with the summary description given above and the detailed description given, below serve to explain the principles of the Hollowing System for a Wood Lathe. However, it is understood that the device is not limited to the precise arrangements shown herein.

FIG. 1 is an isometric computer drawing of the Hollowing System for a Wood Lathe that depicts the major components of the wood lathe and the various assemblies of the Hollowing System for a Wood Lathe.

FIG. 2 an isometric computer drawing of the Hollowing System for a Wood Lathe that depicts the major axes of translation and rotation that are controlled by the present invention.

FIG. 3 is an isometric computer drawing that illustrates the Toolbar and Toolbar Swivel Assemblies.

FIG. 4 is an isometric computer drawing that illustrates the preferred embodiment of the Horizontal/Vertical Toolbar Support Assembly.

FIG. 5 is an isometric computer drawing that illustrates an alternative embodiment of the Horizontal/Vertical Toolbar Support Assembly.

FIG. 6 is an isometric computer drawing that illustrates several Tool Cutter Adapters.

### DETAILED DESCRIPTION OF THE INVENTION

### How to Make the Invention

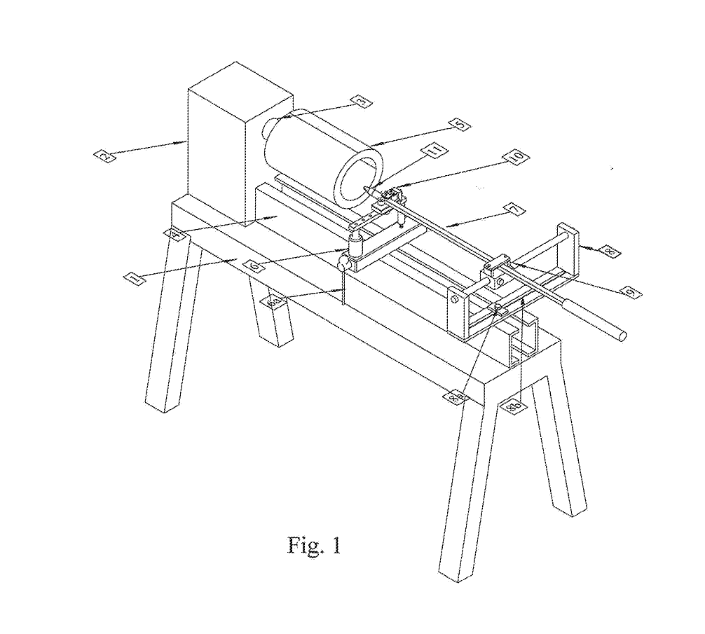

FIG. 1 shows a wood lathe, designated by the reference number 1, comprising a headstock 2, spindle 3, ways 4, and banjo 6. Mounted on the spindle 3 is the work piece 5 that is to be hollowed by using the present invention. The work piece in mounted on the spindle with a chuck, faceplate, or spur drive. The hollowing system of the present invention is comprised of a toolbar 7, a cutter adapter 11, a swivel assembly 10, a toolbar support assembly 8 shown mounted on the lathe ways 4, and a toolbar traversing assembly 9.

The toolbar support assembly 8 is secured on the ways 4 by locking bolt 8a and is easily adjusted to any orientation by rotating it around a vertical axis and sliding it laterally and longitudinally through slot 8b.

Similarly, the swivel assembly 10, which is mounted in the lathe banjo 6, is easily adjusted to any location and orientation by using the banjo locking lever 6a.

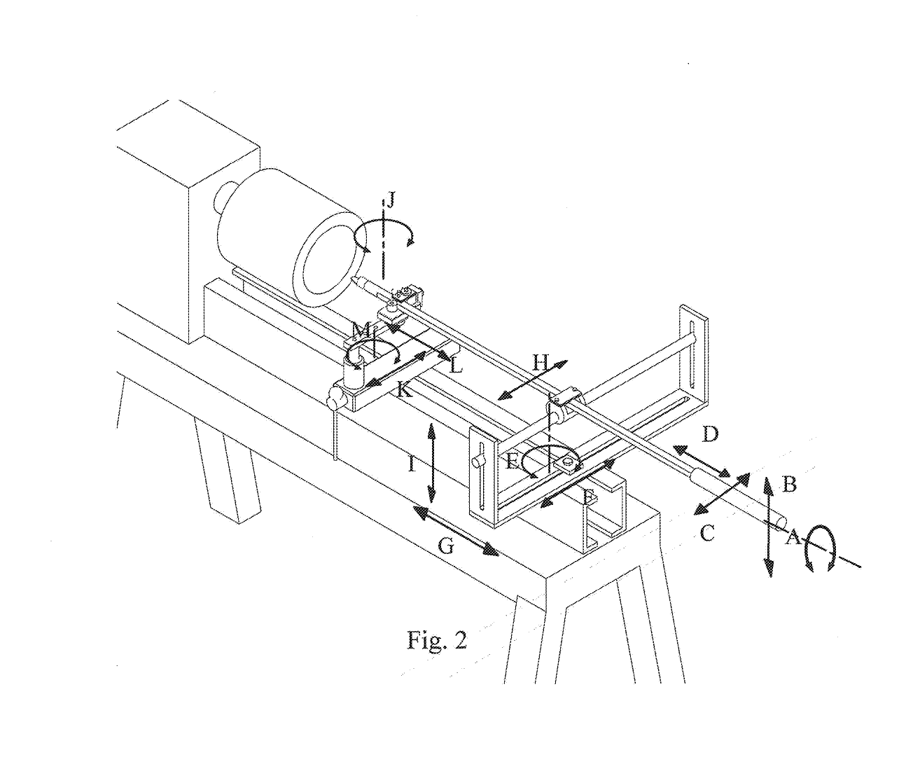

FIG. 2 shows the axes of rotation and translation that are controlled by the Hollowing System for a Wood Lathe. A and B denote the toolbar rotational and vertical axes, respectively, and are the axes experiencing the predominant forces during hollowing. C and B denote toolbar lateral and longitudinal axes, respectively, and are the axes most used during the hollowing process. E, F, G and I are the axes of rotation and translation for the toolbar support assembly, and come into play as the support assembly is repositioned during the hollowing process. Similarly, K, L, and M, refer to repositioning of the banjo 6 during the hollowing process. Finally, J and H denote rotational and translational axes, respectively, and come into play when the toolbar is moved laterally along axis C.

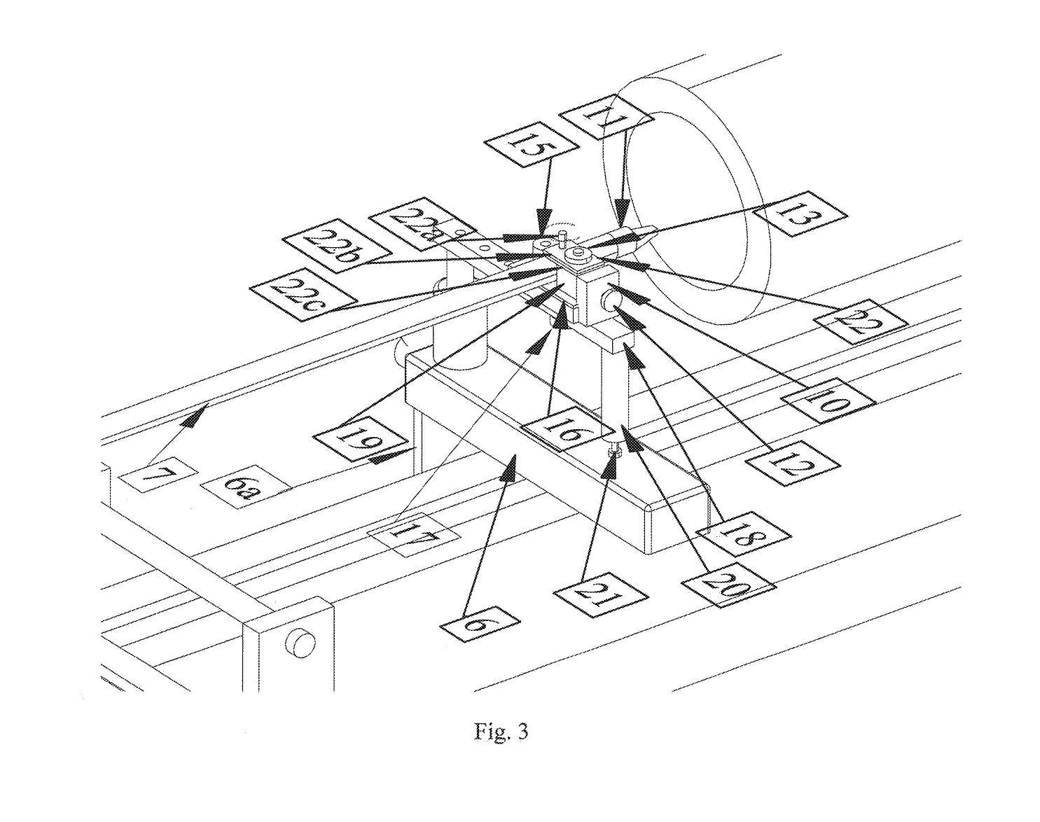

FIG. 3 shows the swivel assembly 10 in more detail. The swivel assembly 10 is mounted in support bar 18 and secured by knurled nut 17. The hole in which 10 is mounted fixes the vertical axis of rotation of the swivel relative to the banjo 6. Knurled bolt 12 provides lateral force to the block 19 which presses against toolbar 7. The lateral force is countered by bearing 15 which engages a flat surface milled on one side of toolbar 7. Together bearing 15 and block 19 prevent the rotation of toolbar 7 about its longitudinal axis. Toolbar restraint 22 comprising 22a, 22b, and 22c provide both friction control (22a) and vertical restraint (22b) to toolbar 7. Pads 16 and 22c are constructed of UHMW-PE that provides vibration damping and friction control. Knurled nut 13 secures both the block 19 and toolbar vertical restraint 22. The vertical post 20 together with adjusting bolt 21 provide flexing and vibration damping to support bar 18.

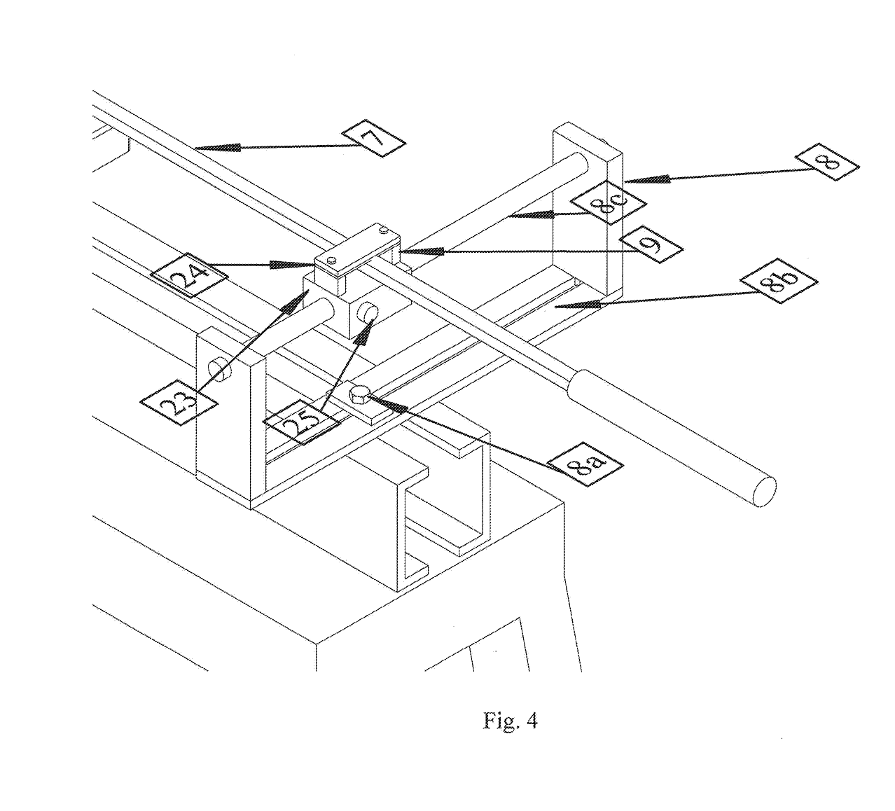

FIG. 4 shows the vertical/horizontal toolbar support assembly 8 and the traversing assembly 9. The traversing assembly 9 is comprised of a linear bearing 23, friction and vibration damping pads 24 and a locking and friction control mechanism 25. The traversing assembly 9 slides along a ground and polished steel shaft 8c. The friction control mechanism 25 allows the friction to be varied between minimal and fully locked (useful for deep plunge cuts).

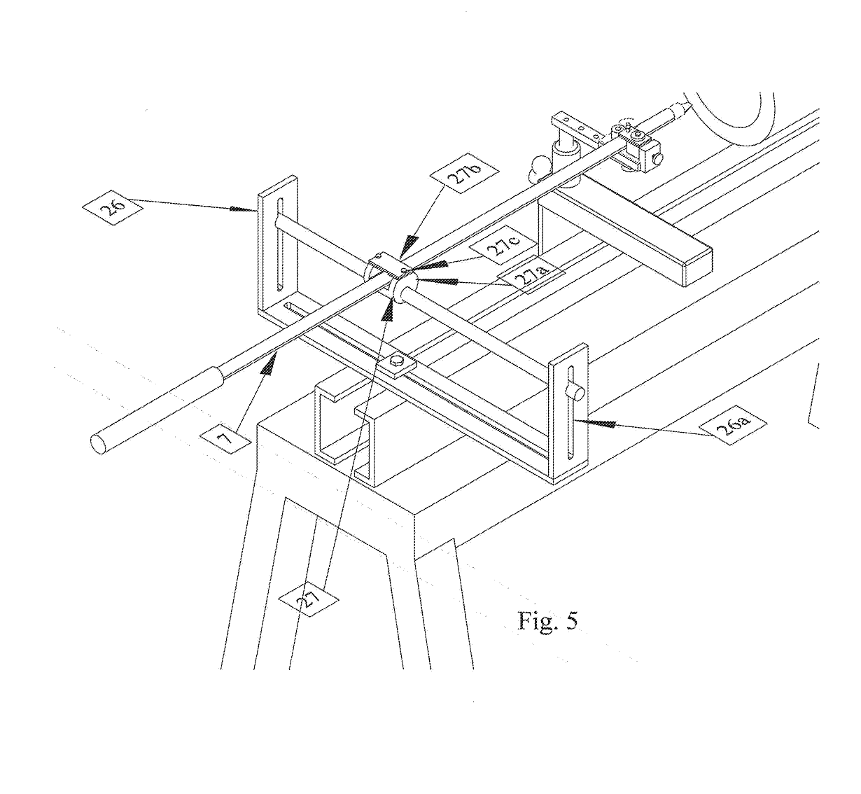

FIG. 5 shows an alternative vertical/horizontal toolbar support assembly 26 and traversing assembly 27. Vertical slots 26a allow the height of toolbar 7 to be easily changed. The traversing assembly 27 is comprised of a sliding bearing 27a machined from Delrin, friction and damping pads 27b, and a friction control mechanism 27c that allows the friction to be varied between minimal and fully locked (useful for deep plunge cuts).

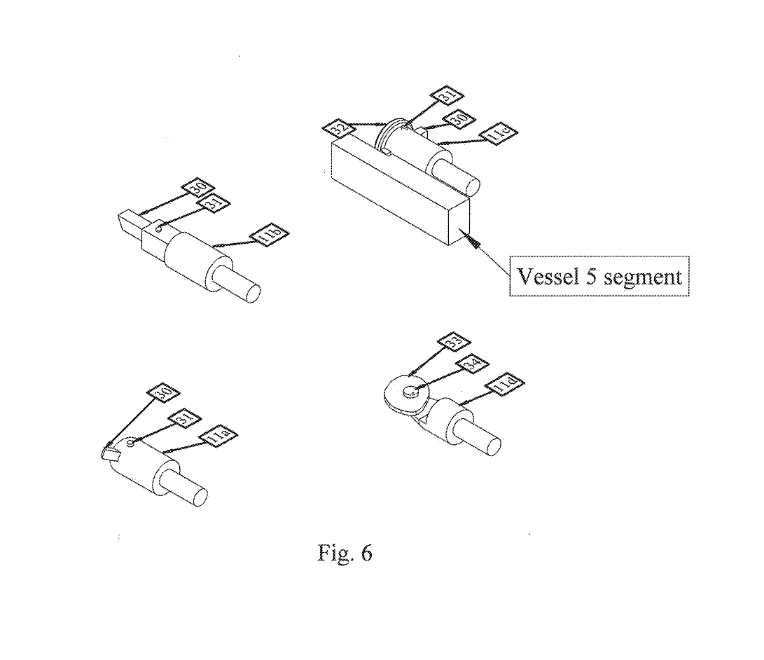

FIG. 6 shows three configurations of cutter adapters 11a, 11b, and 11c. In each case the HSS (high speed steel) tool bits 30 are held by set screws 31 and are shown in their as purchased shape. The wood turner thus has the flexibility of grinding the most appropriate shape on the bit for the intended cuts. Cutter adapter 11c is fitted with a depth stop 32 made of Delrin that limits the depth of cut and which rotates on cutter adapter 11c (the concept is illustrated pictorially with a small segment of vessel 5 wall). Cutter adapter 11d comprising scraper 33 and machine screw 34 would be used for final smoothing of vessel 5 interior walls.

### The Best Mode of the Invention

FIGS. 1, 3, and 4 depict the best mode of the invention.

### How to Use the Invention

The first step in using the invention is to prepare the external shape of the wood blank to be hollowed. In general the starting wood blank, e.g., a burl, would be mounted between lathe centers, and traditional wood turning tools and techniques would be used to obtain the desired final shape. As a last step a tenon would be cut on what is to be the bottom of the vessel. The burl is then turned around and mounted in a chuck that has been placed on lathe spindle 3. Frequently a drill bit would then be used to remove the center of the burl and establish the depth to be hollowed. At this point the Hollowing System for a Wood Lathe would be mounted on the lathe ways as shown in FIG. 1.

Depending upon the desired shape of the finished vessel, a variety of different tool cutters would be mounted in the Hollowing System for a Wood Lathe cutter adapter 11 and used in the hollowing process. Cutter adapter 11a would be used for lateral and longitudinal roughing cuts where the uniformity of the cut is not important. Similarly cutter adapter 11b would be used for longitudinal plunge cuts. Cutter adapter 11c would be used for more controlled cuts as the final wall thickness is approached. Cutter adapter 11d would be used for final smoothing cuts. In general, the hollowing process would proceed from the center and top of the vessel until the desired wall and bottom thicknesses were obtained. These thicknesses could be determined visually, by feel, with calipers, or by one of several commercially available laser or camera-based systems. The final step in the hollowing procedure would consist of sanding to the desired level of smoothness and the application of an appropriate finish.

What is claimed is:

1. A method for using a hollowing system for a wood lathe comprising the steps of: controlling the longitudinal, lateral, vertical, and rotational forces on a toolbar associated with cutting tools used for hollowing vessels on a wood lathe; said forces arising from the interactions of the cutting tool with the rotating vessel; providing three levels of control; a fully locked toolbar, a completely free toolbar; and an intermediate state between the afore mentioned states to cut a hollow system.

2. The method of claim 1 wherein the three levels of control are provided by physical restraints, or the absence thereof.

3. The method of claim 1 wherein the three levels of control are provided by techniques for producing variable system friction.

4. The method of claim 1 wherein the three levels of control are provided by the adjustable control of system physical tolerances.

5. The method of claim 1 wherein the three levels of control are provided by the use vibration damping materials of construction.

6. The method of claim 1 wherein the cutter adapter holds the tool bit at approximately 90 degrees to the toolbar longitudinal axis.

7. The method of claim 1 wherein the cutter adapter holds the tool bit at an angle approximately parallel to the toolbar longitudinal axis.

8. The method of claim 1 wherein the cutter adapter holds the tool bit at approximately 90 degrees to the toolbar longitudinal axis and also has a depth stop constructed of Delrin.

9. The method of claim 1 wherein the cutter adapter is configured to hold a scraper.

10. The method of claim 1 wherein the cutter adapter holds the tool bit at approximately 90 degrees to the toolbar longitudinal axis and the depth stop is a bearing.

11. A hollowing system for a wood lathe comprising: an apparatus for controlling the longitudinal, lateral, vertical, and rotational forces on a toolbar associated with cutting tools used for hollowing vessels on a wood lathe; said forces arising from the interactions of the cutting tool with the rotating vessel; a toolbar with adapters for holding cutters; a toolbar swivel assembly; a toolbar support assembly; and a toolbar traversing assembly.

12. The apparatus of claim 11 wherein the toolbar is cylindrical in cross-section with a flat surface machined on one side.

13. The apparatus of claim 11 wherein the toolbar is drilled longitudinally to accept cutter adapters.

14. The apparatus of claim 11 wherein the toolbar is a square tube that can accept square tool bits.

15. The apparatus of claim 11 wherein a swivel assembly having a toolbar axial rotation and vertical constraint, longitudinal friction control, and vibration damping,

16. The apparatus of claim 11 wherein the axial rotation constraint comprise: a bearing and a bolt to provide lateral force to a Delrin block that presses against the toolbar.

17. The apparatus of claim 11 wherein the vertical constraint comprises: a toolbar restraint that provides vertical restraint; friction control; and vibration damping.

18. The apparatus of claim 11 wherein a vertical/horizontal toolbar support assembly has a lateral, longitudinal and rotation means; a ground and polished steel shaft; and a traversing assembly.

19. The apparatus of claim 11 wherein the traversing assembly is comprised of a linear bearing, friction pads; damping pads, and a friction control mechanism.

20. The apparatus of claim 11 wherein the traversing assembly is comprised of a sliding bearing machined from Delrin; friction pads; damping pads; and a friction control mechanism.
